(19) United States
(12) Patent Application Publication
(10) Pub. No.: US 2026/0059617 A1
(43) Pub. Date: Feb. 26, 2026

(54) SYSTEM AND METHOD FOR PHASE MEASUREMENT IN A HALF-BRIDGE RESONANT TANK

(71) Applicant: Haier US Appliance Solutions, Inc., Wilmington, DE (US)

(72) Inventor: Nathaniel Lehrer, Louisville, KY (US)

(21) Appl. No.: 18/812,098

(22) Filed: Aug. 22, 2024

(51) Int. Cl. H05B 6/06; H05B 6/12

(52) U.S. Cl. CPC H05B 6/062; H05B 6/1209; H05B 2213/05

(57) ABSTRACT

An induction heating system for an induction cooking appliance is provided. The induction heating system includes an induction coil configured to inductively heat a load. The induction heating system further includes an inverter system configured to provide an alternating current to the induction coil. The induction heating system further includes a polarity processing circuit configured to determine a polarity signal indicating a first polarity state and a second polarity state of the alternating current to the induction coil. The induction heating system further includes a phase processing circuit configured to determine a current phase signal indicative of a current phase of the induction coil based at least in part on the polarity signal in the first polarity state and the polarity signal in the second polarity state.

### FIELD

Example aspects of the present disclosure relate generally to induction heating systems used, for instance, in induction cooking appliances, and more particularly to measuring a phase associated with an induction coil of a multi-coil induction cooking appliance.

### BACKGROUND

Induction cooking appliance (e.g., induction cook-tops) heat conductive cookware by magnetic induction. An induction cooking appliance applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to an induction heating system for an induction cooking appliance. The induction heating system includes an induction coil configured to inductively heat a load. The induction heating system further includes an inverter system configured to provide an alternating current to the induction coil. The induction heating system further includes a polarity processing circuit configured to determine a polarity signal indicating a first polarity state and a second polarity state of the alternating current to the induction coil. The induction heating system further includes a phase processing circuit configured to determine a current phase signal indicative of a current phase of the induction coil based at least in part on the polarity signal in the first polarity state and the polarity signal in the second polarity state.

Another example aspect of the present disclosure is directed to a method for determining a current phase of an induction coil in an induction cooking appliance. The method includes determining a polarity signal indicating a first polarity state and a second polarity state of current to the induction coil. The method further includes determining a current phase signal indicative of the current phase based at least in part on the first polarity state and the second polarity state. The method further includes determining the current phase of the induction coil based at least in part on the current phase signal.

Another example aspect of the present disclosure is directed to an induction cooking appliance. The induction cooking appliance includes a user interface comprising one or more user input devices. The induction cooking appliance further includes an induction heating system for an induction cooking appliance. The induction heating system includes an induction coil configured to inductively heat a load. The induction heating system further includes an inverter system configured to provide an alternating current to the induction coil. The induction heating system further includes a polarity processing circuit configured to determine a polarity signal indicating a first polarity state and a second polarity state of the alternating current to the induction coil. The induction heating system further includes a phase processing circuit configured to determine a current phase signal indicative of a current phase of the induction coil based at least in part on the polarity signal in the first polarity state and the polarity signal in the second polarity state.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 provides a block diagram of an example induction heating system according to example embodiments of the present disclosure;

FIG. 3 depicts a schematic implementation of an example inverter system and an example induction coil of an example induction heating system according to example embodiments of the present disclosure;

FIG. 4 depicts a schematic implementation of an example polarity processing circuit according to example embodiments of the present disclosure;

FIG. 5 depict schematic implementation of an example phase processing circuit according to example embodiments of the present disclosure;

FIG. 6 provides graphical representations of example signals of the induction heating system according to example embodiments of the present disclosure;

FIG. 7A-7B provide graphical representation of example measured current phase values; and

FIG. 8 provides an example method for determining a current phase of an induction coil in an induction cooking appliance.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Induction cooking appliances may have induction heating systems configured to heat a load (e.g., a pan, cookware, vessel, etc.). Specifically, an induction heating system may include one or more coils (e.g., induction coils) operable to inductively heat one or more loads with a magnetic field and an inverter system operable to supply alternating current to the coil. Induction coil parameters such as the induction coil current phase are important in deciding a variety of operational characteristics/states of the induction heating system. For example, induction coil current phase measurements may be used to determine an output power of the induction coil or if a load is present on a coil of the induction cooking appliance.

In general, induction coil current phase with respect to the applied inverter voltage (e.g., induction coil current phase) may be determined based at least in part on a measured signal indicating the current to the induction coil. Some induction heating systems may determine the induction coil current phase with a unipolar measurement of the coil current. For example, current phase determined with unipolar measurements may only be sampled once per cycle, such as during the positive polarity state of the measured coil current. Further, unipolar measurements performed with passive input circuitry may lack symmetry to cancel imbalances in threshold levels, negatively impacting the accuracy of the determined value.

In addition, some induction heating systems may use expensive and/or nonideal methods to measure the induction coil current (e.g., and determine the coil current phase). For instance, current transducers (current transformer, Hall Effect sensor, etc.) or relying on complex arithmetic of quickly sampled A/D data may call for expensive components with tight tolerances. Additionally, shunt resistors may provide signals with high noise that may lead to faulty data and design compromises. Active input circuitry and/or computationally intensive controller routines may be used to determine the coil current phase with unipolar measurements. However, such circuit components may be delicate and expensive to manufacture.

As such, example aspects of the present disclosure provide systems and methods for accurately determining the phase of the coil current with bi-polar measurements. For example, current phase determined with bi-polar measurements may be sampled twice per cycle, such as during the positive polarity state and during the negative polarity state of the measured coil current. The use of both current polarities in generating the current phase signal may provide for increased accuracy in determining the induction coil phase. In addition, example aspects of the present disclosure provide for bi-polar passive current sensing. The passive components may provide for a more cost effective and robust system. Further, the bi-polar measurements performed with the passive input circuitry may provide symmetry to cancel imbalances in threshold levels, improving the accuracy of the determined current phase.

Example aspects of the present disclosure provide numerous technical effects and benefits. For instance, an induction heating system according to the present disclosure may provide for a cost effective, robust method for determining induction coil current phase. In addition, aspects of the present disclosure may provide for improved accuracy and precision in determining induction coil current phase.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions. Referring now to the figures, example aspects of the present disclosure will be discussed in greater detail.

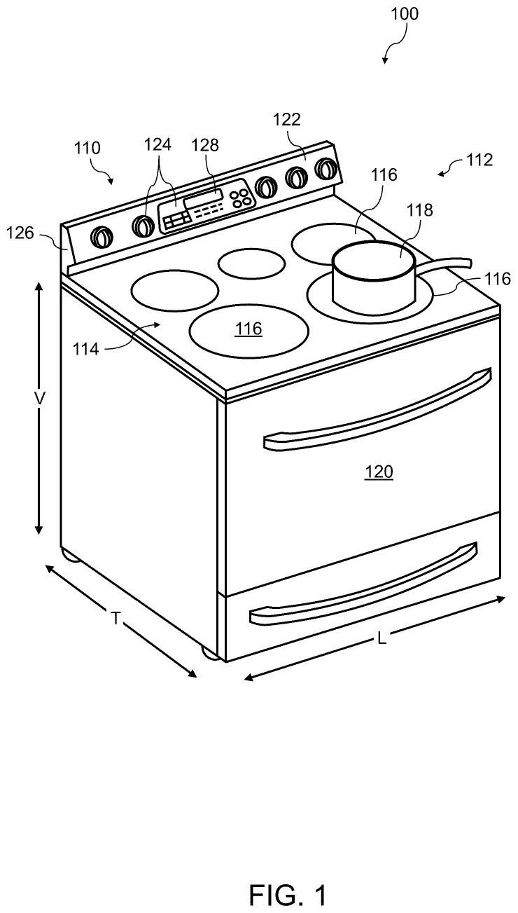

FIG. 1 depicts a perspective view of an induction cooking appliance 100. The induction cooking appliance include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes one or more induction heating elements 116. As shown in FIG. 1, cooktop 112 may include a plurality of heating elements 116. The heating elements 116 are generally positioned at, e.g., on or proximate to, the cooking surface 114. For the embodiment depicted, the cooktop 112 includes five heating elements 116 spaced along cooking surface 114. However, in other embodiments, the cooktop 112 may include any other suitable shape, configuration, and/or number of heating elements 116. Each of the heating elements 116 may be induction heating elements 116 including induction coils, or cooktop 112 may include a combination of different types of heating elements 116. For example, in various embodiments, the cooktop 112 may include any other suitable type of heating elements 116 in addition to the induction heating element, such as a resistive heating element or gas burners, etc.

As shown in FIG. 1, a load 118 (e.g., cooking vessel), such as a pot, pan, or the like, may be placed on an induction heating element 116 to heat the load 118 and cook or heat food items placed in load 118. Induction cooking appliance 100 may also include a door 120 that permits access to a cooking chamber (not shown) of induction cooking appliance 100, e.g., for cooking or baking of food items therein. A user interface 122 (e.g., control panel) having user input devices 124 (e.g., user input devices) may permit a user to make selections for cooking of food items. Although shown on a backsplash or back panel 126 of induction cooking appliance 100, user interface 122 may be positioned in any suitable location. User input devices 124 may include buttons, knobs, and the like, as well as combinations thereof, and/or user input devices 124 may be implemented on a remote user interface device such as a smartphone, tablet, etc. As an example, a user may manipulate one or more user input devices 124 to select a temperature and/or a heat or power output for each heating element 116. The selected temperature or heat output of heating element 116 affects the heat transferred to load 118 placed on heating element 116. The user interface 122 may also include a display 128.

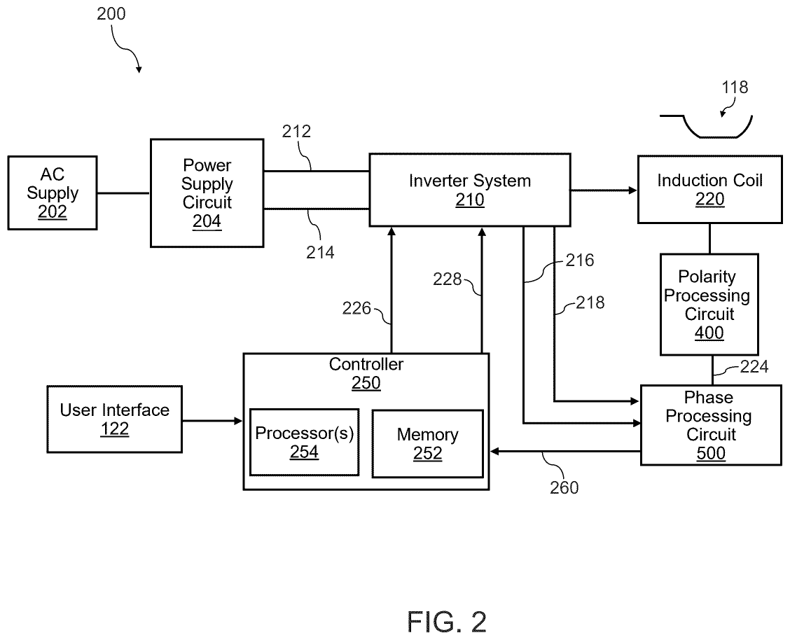

The induction cooking appliance 100 may include a control system for controlling one or more of the plurality of heating elements 116. Specifically, the control system may include a controller operably coupled to the user interface 122 (e.g., user input devices 124 and/or display 128). The controller may be operably coupled to each of the plurality of heating elements 116 for controlling a heating level each of the plurality of heating elements 116 in response to one or more user inputs received through the user interface 122 and user input devices 124. The controller may also provide output to the display 128, such as an indication of a selected power level, which heating element(s) 116 is or are activated, etc. Furthermore, as will be discussed in greater detail below, the control system may further be configured to control operation of an induction heating system 200 (FIG. 2) of the induction cooking appliance 100.

Referring now to FIG. 2, a block diagram of an induction heating system 200 for an induction cooking appliance is provided. While induction heating system 200 is discussed with reference to induction cooking appliance 100 of FIG. 1, those of ordinary skill in the art will understand that induction heating system 200 may be used in any suitable cooking system without deviating from the scope of the present disclosure.

Induction heating system 200 generally includes a power supply circuit 204. Power supply circuit 204 may receive AC power from an AC supply 202, which may provide conventional 60 Hz 120 or 240 volt AC supplied by utility companies. Power supply circuit 204 may include rectification circuitry for rectifying the power signal from the AC supply 202. In addition, power supply circuit 204 may include filtering and power factor correction circuitry to filter the rectified power signal. In some embodiments, AC supply 202 and/or power supply circuit 204 is configured to provide AC power to multiple induction coils 220.

Induction heating system 200 further includes an inverter system 210, such as a half-bridge resonant inverter system configured to provide an alternating current to induction coil 220 to inductively heat load 118. Inverter system 210 may receive power from power supply circuit 204. Specifically, the inverter system 210 may be operatively coupled to the power supply circuit 204 by a high-side path 212 and a low-side path 214. In some embodiments, high-side path 212 may be defined by a bus voltage, which is supplied to inverter system 210 by power supply circuit 204. Low-side path 214 may be defined by a ground supplied to low-side path 214 by power supply circuit 204. In some embodiments, inverter system 210 may include a variable frequency inverter.

Induction coil 220 may be defined as an induction heating element, such as induction heating element 116 as shown in FIG. 1. The induction coil 220, when supplied with alternating current, may inductively heat load 118 (e.g., pan, cooking vessel) or other object placed on, over, or near the coil 220. It will be understood that use of the term “load” herein is used merely as an example, and that term will generally include any object of a suitable type that is capable of being heated by an induction heating coil.

The switching frequency of the alternating current supplied to the induction coil 220 by inverter system 210 may be controlled by a controller 250. As shown, controller 250 may be operatively coupled to the inverter system 210 to control the output power of the induction coil 220 by controlling the switching frequency of inverter system 210. Controller 250 may include a microcontroller and/or gate driver circuitry to drive individual transistors or switching devices of the inverter system 210. In some embodiments, controller 250 may provide one or more switching signals 226, 228 to one or more gate drivers of the inverter system 210. For example, switching signal 226 may be provided to a high side gate driver and switching signal 228 may be provided to a low side gate driver.

As shown, controller 250 may include memory 252 and one or more processors 254 such as microprocessors, CPUs or the like, such as general or special purpose microprocessors operable to execute programming instructions or micro-control code associated with operation of induction cooking appliance 100. Memory 252 may represent random access memory such as DRAM, or read only memory such as ROM or FLASH. In one embodiment, the processor 254 executes programming instructions stored in memory 252. Memory 252 may be a separate component from controller 250 or may be included onboard controller 250.

Induction heating system 200 further includes a polarity processing circuit 400. Polarity processing circuit 400 is configured to determine a polarity signal 224 indicating a first polarity state and a second polarity state of the alternating current to the induction coil 220. For example, the first polarity state may correspond to current moving through induction coil 220 in a first direction while the second polarity state may correspond to current moving through induction coil 220 in a second (e.g., opposite direction). Accordingly, polarity signal 224 may be a digital signal with a high voltage amplitude corresponding to the first polarity state and a low voltage amplitude corresponding to the second state.

Polarity processing circuit 400 may generate polarity signal 224 based at least in part on a current measurement signal indicative of the current to induction coil 220. Specifically, current measurement signal may be a voltage signal representative of the current to induction coil 220. For instance, polarity processing circuit 400 may include a sensing component configured to determine the current measurement signal. In some embodiments, the sensing component of the polarity processing circuit 400 may be a passive network circuit, such as a resistor-capacitor (RC) circuit operatively coupled to the induction coil 220. Alternatively, the sensing component of polarity processing circuit 400 may be a shunt current sensor, current transformer, hall effect sensor, or any other suitable sensing device or system. In some embodiments, the sensing component of the polarity processing circuit 400 may include an active circuit (e.g., amplifier) that facilitates sensing the current measurement signal indicative of the current to induction coil 220.

Induction heating system 200 further includes a phase processing circuit 500. Polarity processing circuit 400 may provide polarity signal 224 to phase processing circuit 500 configured to determine a current phase signal 260 indicative of a current phase of the induction coil 220. Specifically, phase processing circuit 500 is configured to determine the current phase signal 260 based at least in part on the polarity signal 224 in the first polarity state and the polarity signal 224 in the second polarity state. For instance, a first portion (e.g., first polarity phase signal) of current phase signal 260 may be based at least in part on polarity signal 224 in the first polarity state and a second portion (e.g., second polarity phase signal) of current phase signal 260 may be based at least in part on polarity signal 224 in the second polarity state.

As shown in FIG. 2, phase processing circuit 500 may also receive gate driver signals 216, 218. Gate driver signals 216, 218 may be pulse-width modulated (PWM) signals configured to control (e.g., drive) switching devices of the inverter system 210. In some embodiments, inverter system 210 may include gate drivers configured to provide the gate driver signals 216, 218 to the switching devices. Alternatively, controller 250 may include gate driver circuitry within the controller package that may directly interface the switching devices of the inverter system 210. Accordingly, in some embodiments, gate driver signals 216, 218 may be provided by controller 250, such as with switching signals 226, 228.

In some embodiments, the current phase signal 260 may be based at least in part on the first gate driver signal 216 when the polarity signal 224 is in the first polarity state and the second gate driver signal 218 when the polarity signal 224 is in the second polarity state.

Phase processing circuit 500 may be configured to provide current phase signal 260 to controller 250. Controller 250 may be configured to determine the current phase of induction coil 220 based at least in part on the current phase signal 260. For example, controller 250 may measure the pulse widths of the current phase signal 260 over, for example, one full coil current cycle. The current phase may then be determined by averaging the pulse widths measured. In some embodiments, this determination may be implemented using low power consumption peripherals such as a general-purpose input/output (GPIO) peripheral. Alternatively, the current phase signal 260 may be filtered by a filtering circuit (e.g., low pass filter). The filtered current phase signal 260 may then be provided to an analog-to-digital converter (ADC) over, for example, one full current cycle to determine the current phase.

In addition, controller 250 may be configured to determine one or more operational characteristics/states of induction heating system 200, such as an output power and/or a load presence of the induction coil, based at least in part on current phase signal 260 and/or the current phase. For instance, the current phase determined from current phase signal 260 may be defined as a measured phase value. The magnitude of the measured phase value may vary depending on the presence of a pan proximate induction coil 220. For example, the magnitude of the measured phase value may be greater when a pan is not present than when a pan is present. In addition, other characteristics of the load such as the size and type may be determined based on the measured phase value. Similarly, a measured output power of the induction coil 220 may be calculated by a controller, such as controller 250, using the measured phase value.

User interface 122 may also be operatively coupled to controller 250. In some embodiments, user interface 122 may allow a user to establish a desired power output of the induction heating coil 220 by, for example, selecting a power setting from a plurality of user selectable settings. In some embodiments, controller 250 may be configured to control the output power of the induction coil 220 by determining and/or adjusting the switching frequency of inverter system 210 based at least in part on the desired power setting set by the user, the measured output power, and/or the presence of the load.

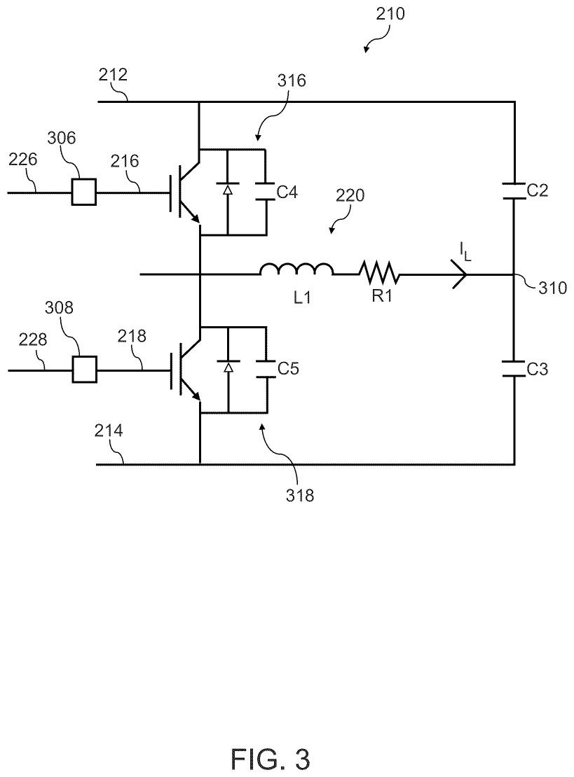

Referring now to FIG. 3, a circuit schematic depicting an example inverter system and induction coil is provided. Inverter system 210 and induction coil 220 may be implemented in any suitable induction heating system, such as induction heating system 200 of FIG. 2.

As shown in FIG. 3, inverter system 210 is configured to provide an alternating current (I_{L}) through the induction coil 220. The induction coil 220 and, if present, load 118 (shown in FIGS. 1 and 2) may be represented (e.g., modeled) in FIG. 3 as an inductor L1 (e.g., coil 220) and a resistor R1 (e.g., load 118). As shown, induction coil 220 may be coupled to high-side switching device 316 and low-side switching device 318. Specifically, inverter system 210 may be a half-bridge resonant inverter system with switching devices 316, 318 on one side of the coil and resonant capacitors C2, C3 on the other side of the coil. As previously described, inverter system 210 may include switching devices 316, 318 that provide alternating current (I_{L}) through the induction coil 220 at a desired frequency set by, for example, controller 250 (FIG. 2). Specifically, high-side switching device 316 may control (e.g., open or close) the flow of current based on high-side gate driver signal 216 provided by high-side gate driver 306. Similarly, low-side switching device 318 may control (e.g., open or close) the flow of current based on low-side gate driver signal 218 provided by low-side gate driver 308. Gate driver signals 216, 218 may be determined based on switching signals 226, 228 provided to gate drivers 306, 308 by a controller, such as controller 250 (FIG. 2).

In some embodiments, switching devices 316, 318 may be Insulated-Gate Bipolar Transistors (e.g., IGBTs). However, other suitable switching devices (e.g., MOSFETs) may be used without deviating from the scope of the present disclosure. Switching devices 316, 318 may be configured in parallel with capacitors (e.g., snubber capacitors) C4 and C5 respectively.

Inverter system 210 may be a resonant inverter system, such as a half-bridge resonant inverter system, with one or more resonant capacitors. As shown in FIG. 3, the one or more resonant capacitors may include a high-side resonant capacitor C2 and a low-side resonant capacitor C3. As previously described with reference to FIG. 2, inverter system 210 may be operatively coupled to power supply circuit 204 (FIG. 2) by high-side path 212 and a low-side path 214. Induction coil 220 and resonant capacitors C2 and C3 may form a resonant tank. In some embodiments, a measurement node 310 may be defined within the resonant tank, such as between the two resonant capacitors (e.g., C2 and C3). For example, measurement node 310 may be defined between the induction coil 320 and the one or more resonant capacitors (e.g., C2 and C3). In some embodiments, a polarity processing circuit, such as polarity processing circuit 400 of FIG. 2 may be operable coupled to measurement node 310.

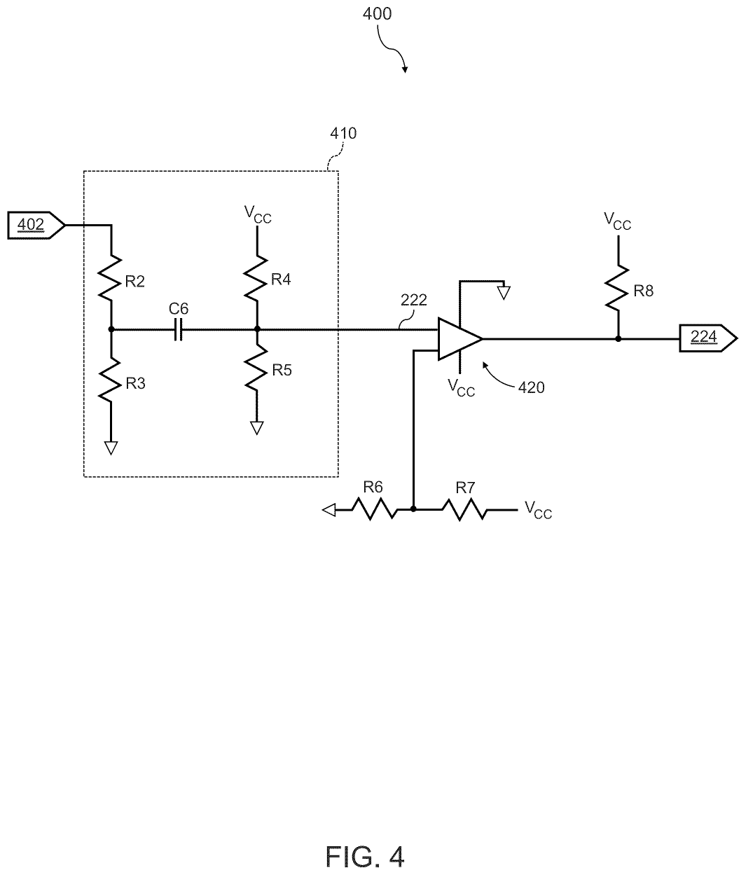

FIG. 4 provides a circuit schematic depicting an example polarity processing circuit according to example embodiments of the present disclosure. Polarity processing circuit 400 of FIG. 4 may be implemented in any suitable induction heating system, such as induction heating system 200 of FIG. 2.

As shown in FIG. 4, polarity processing circuit 400 may include a sensing component 410 configured to determine a current measurement signal 222 indicative of current to the induction coil. In some embodiments, current measurement signal 222 may be determined based at least in part on a voltage signal 402 indicative of a voltage at a node defined between the induction coil and one or more resonant capacitors of the inverter system. For example, voltage signal 402 may be provided to sensing component 410 from measurement node 310 as shown in FIG. 3. Specifically, voltage signal 402 may be provided to a voltage divider (e.g., resistors R2 and R3) configured to scale voltage signal 402 to an appropriate voltage level. Sensing component 410 may further include high-pass filter circuitry (e.g., capacitor C6 and resistors R4 and R5) configured to perform a differentiation operation on the voltage signal 402 in order to obtain a signal proportional to the coil current. Additionally, the configuration of R4 and R5 may provide a DC bias which may be set equal to a DC bias set by the combination of R6 and R7. As shown in FIG. 4, sensing component 410 may be a passive network circuit, such as a resistor-capacitor (RC) circuit. While sensing component 410 is shown in FIG. 4 as a passive network circuit, those of ordinary skill in the art will understand that polarity processing circuit 400 may include other types of sensing components. For example, polarity processing circuit 400 may include an active circuit (e.g., amplifier) configured to determine measurement signal 222 indicative of current to the induction coil.

Polarity processing circuit 400 may further include comparator 420. As shown, comparator 420 may receive current measurement signal 222 from sensing component 410. While comparator 420 is depicted in FIG. 4 as receiving the current measurement signal 222 from sensing component 410, those of ordinary skill in the art will understand that current measurement signal 222 may alternatively be provided to comparator 420 of polarity processing circuit 400 by any suitable sensing device or system such as a shunt current sensor, current transformer, or hall effect sensor.

The comparator 420 may compare current measurement signal 222 to a polarity crossover threshold in order to determine polarity signal 224. For example, if the current measurement signal 222 is greater than the polarity crossover threshold, polarity signal 224 may be determined in a first polarity state. If the current measurement signal 222 is less than the polarity crossover threshold, polarity signal 224 may be determined in a second polarity state.

In some embodiments, the polarity crossover threshold may have a tolerance such that the polarity signal may be unintentionally biased towards one of the two polarity states, thereby skewing the phase measurement for a given phase measurement over one polarity of the switching cycle. For example, a digital signal corresponding to the phase of the coil current may have a 50% duty cycle (e.g., an equal 180 degree phase difference from one polarity edge to the adjacent edges). Furthermore, the crossover threshold tolerance and sensed coil current DC bias tolerance contributed by component values may tend to shift the duty cycle of this digital signal away from 50%. For instance, the polarity crossover threshold may be defined as a voltage value provided by a voltage divider (e.g., resistors R7 and R6) configured to scale a voltage (V_{CC}) to a value appropriate for the polarity crossover threshold, such as about half the value of voltage (V_{CC}). The resistor tolerance of resistors R7 and R6 may cause a tolerance in the polarity crossover threshold. For example, resistors R7 and R6 may have a resistor tolerance greater than 1%. In some embodiments, voltage (V_{CC}) provided through pull-up resistor R8 may be applied to the output of comparator 420 to generate polarity signal 224.

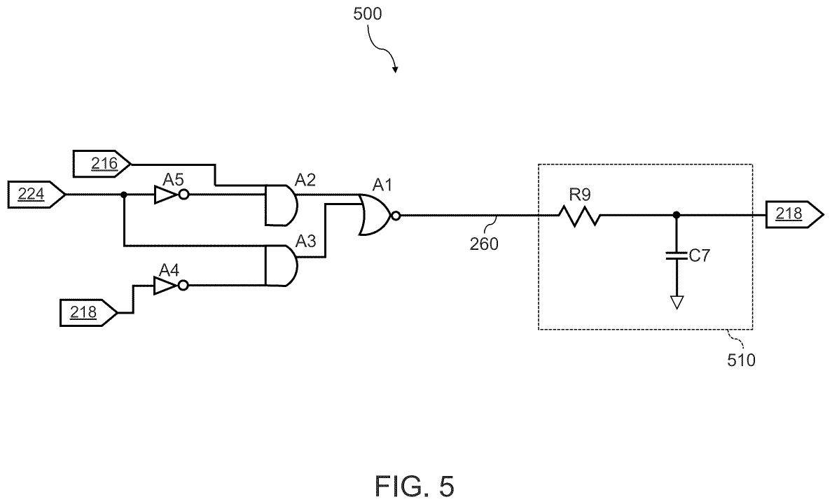

Referring now to FIG. 5, an example phase processing circuit 500 is provided. Phase processing circuit 500 of FIG. 5 may be implemented in any suitable induction heating system, such as induction heating system 200 of FIG. 2. While phase processing circuit 500 is depicted with one or more logic gates, those of ordinary skill in the art will understand that phase processing circuit 500 may include any applicable circuit components configured to perform the logic depicted. For example, phase processing circuit 500 may include an integrated circuit (IC) configured to perform the logic depicted in FIG. 5.

As shown in FIG. 5, phase processing circuit 500 may receive polarity signal 224 and gate driver signals 216, 218 from, for example, polarity processing circuit 400 (FIG. 4).

As shown at A2, first gate driver signal 216 may be compared (e.g., using an AND gate) with the inverted polarity signal 224. At A3, polarity signal 224 is compared (e.g., using an AND gate) with the inverted second gate driver signal 218. At A1, the resulting signal from A2 is compared (e.g., using a NOR gate) with the resulting signal from A3. As shown, the resulting signal may be current phase signal 260. In some embodiments, phase processing circuit 500 further includes a low pass filtering circuit 510 (e.g., resistor R9 and capacitor C7) configured to filter current phase signal 260. For example, low pass filtering circuit 510 may filter current phase signal 260 to a value appropriate for a controller, such as controller 250 (FIG. 2). As such, phase processing circuit 500 (e.g., low pass filtering circuit 510 of phase processing circuit 500) may provide current phase signal 260 to a controller, such as controller 250 of FIG. 2.

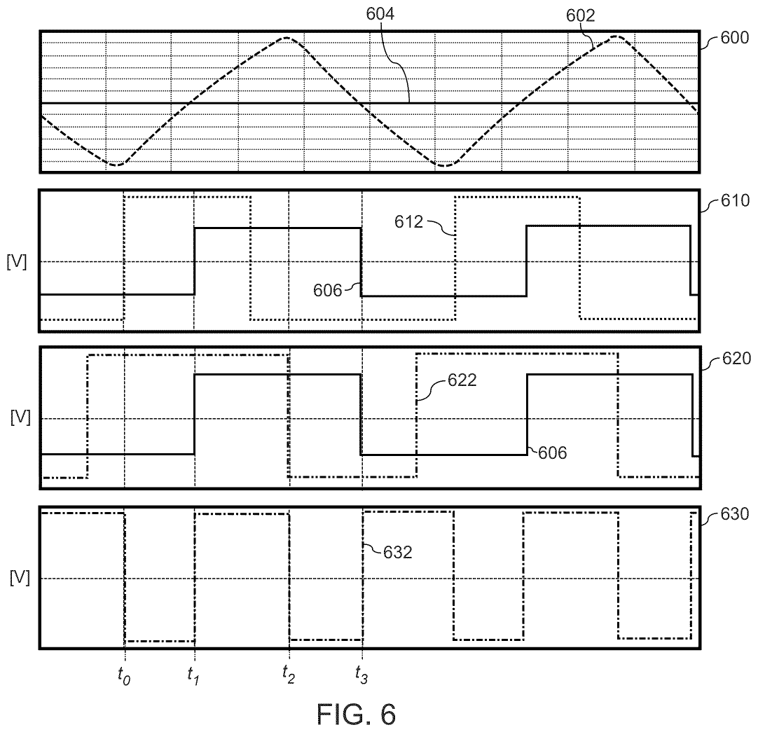

FIG. 6 depicts graphical representations of example signals of an induction heating system according to example embodiments of the present disclosure. Specifically, FIG. 6 includes example signals of induction heating system 200 shown in FIG. 2.

As shown in plot 600, an example coil current 602 may be compared with a polarity crossover threshold 604, as previously described with reference to FIG. 4. Accordingly, a current polarity signal 606 may be determined based at least in part on the polarity crossover threshold 604. As shown in plot 610 and plot 620, polarity signal 606 may indicate a first polarity state when the example coil current 602 is greater than the polarity crossover threshold 604 and a second polarity state when the example coil current 602 is less than the polarity crossover threshold 604.

Plot 610 shows the example polarity signal 606 and an example first gate driver signal 612 while plot 620 shows the example polarity signal 606 and an example second gate driver signal 622.

Plot 630 shows an example current phase signal 632 indicating the current phase. Current phase signal 632 may be determined based on a comparison of the example signals of plots 610 and 620. Specifically, current phase signal 632 may be determined by the first gate driver signal 612 when the polarity signal 606 is in the first polarity state and the second gate driver signal 622 when the polarity signal 606 is in the second polarity state. For example, before t₁, polarity signal 606 is low (e.g., first polarity state). First gate driver signal 612 has a rising edge at t₀. As such, current phase signal 632 may be low from t₀ to t₁, indicating the first gate driver signal 612 when polarity signal 606 is in the first polarity state. Similarly, current phase signal 632 may be low from t₂ to t₃, indicating the second gate driver signal 622 being low when the polarity signal 606 is high (e.g., second polarity state). As shown, current phase signal 632 may be a bi-polar phase measurement determined in the first polarity state and the second polarity state.

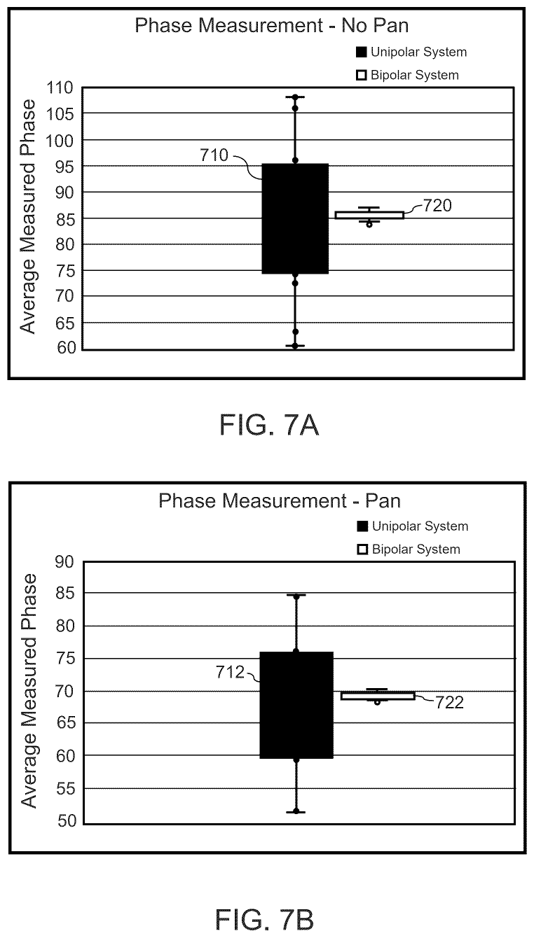

FIG. 7A-7B provide graphical representations of example measured current phase values with variations in component values due to tolerance. Specifically, FIG. 7A-7B show bi-polar phase measurement according to example embodiments of the present disclosure in comparison to a unipolar phase measurement system.

FIG. 7A provides a graphical representation of measured phase values (e.g., current phase values) of an induction coil without a load (e.g., pan) present, while FIG. 7B provides a graphical representation of measured phase values of induction coils when a load is present. As shown in FIG. 7A-7B, a unipolar circuit may provide example phase measurements 710 when no load is present and example phase measurements 712 when the load is present. As shown, the phase measurements 710, 712 provided by the unipolar circuit span over a wide range (e.g., regardless of if a pan is present or not). Accordingly, unipolar phase measurements 710 taken with no pan present may overlap with phase measurements 712 taken when the pan is present. This may be due to, for instance, a lack of symmetry to cancel imbalances of threshold levels in the unipolar circuit. Accordingly, a unipolar circuit may not perform at acceptable levels to accurately determine the presence of a load (e.g., pan).

Alternatively, aspects of the present disclosure provide a bi-polar measurement circuit that may provide example phase measurements 720 when a pan is not present and example phase measurements 722 when a pan is present.

As shown, phase measurements 720 have distinct values when compared to phase measurements 722, which may allow for accurately determining a load presence of an induction coil. Specifically, example phase measurements 720, 722 may be determined by a controller, such as controller 250 of FIG. 2, based at least in part on a current phase signal, such as current phase signal 260 provided by phase processing circuit 500 of FIGS. 2 and 5.

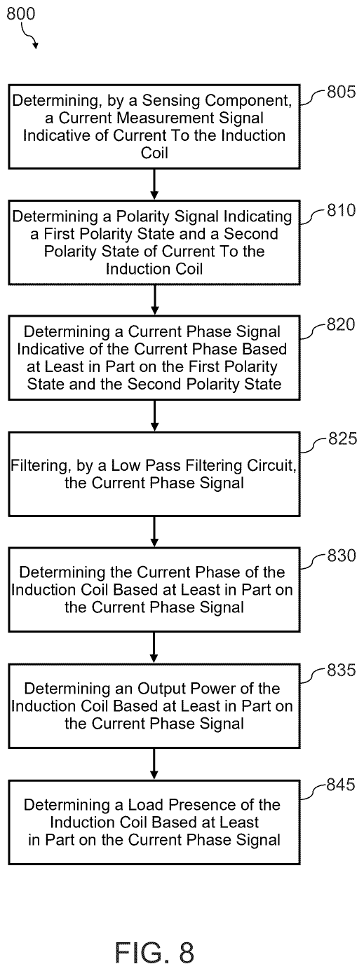

FIG. 8 provides an example method 800 for determining a current phase of an induction coil in an induction cooking appliance. While method 800 is generally discussed with reference to induction heating system 200 as shown in FIG. 2, those of ordinary skill in the art will understand that method 800 may be implemented in any applicable induction heating system and/or induction cooking appliance. Method 800 provides a series of steps performed in a particular order for purposes of illustration and discussion. Those of ordinary skill in the art, using the disclosures provided herein, will understand that any step of method 800 discussed herein can be adapted, rearranged, expanded, omitted, or modified in various ways without deviating from the scope of the present disclosure.

In some embodiments, method 800 may include, at (805), determining, by a sensing component, a current measurement signal indicative of current to the induction coil. For example, sensing component 410 (FIG. 4) may provide a current measurement signal 222 indicative of a current to the induction coil.

At (810), method 800 includes determining a polarity signal indicating a first polarity state and a second polarity state of current to the induction coil. For example, polarity processing circuit 400 may determine polarity signal 224. Polarity signal 224 may indicate a first polarity state and a second polarity state of current to the induction coil. In some embodiments, polarity signal 224 may be based at least in part on current measurement signal 222.

At (820), method 800 includes determining a current phase signal indicative of the current phase based at least in part on the first polarity state and the second polarity state. For example, phase processing circuit 500 may determine current phase signal 260 by comparing first gate driver signal 216 to the polarity signal 224 when in the first state and comparing the second gate driver signal 218 to the polarity signal 224 when in the second state.

In some embodiments, method 800 may include, at (825), filtering, by a low pass filtering circuit, the current phase signal. For example, as shown in FIG. 5, phase processing circuit 500 may include low pass filtering circuitry 510 configured to filter current phase signal 260.

At (830), method 800 includes determining the current phase of the induction coil based at least in part on the current phase signal. For example, controller 250 may determine the current phase of induction coil 220 based at least in part on the current phase signal 260.

In some embodiments, method 800 may include, at (835), determining an output power of the induction coil based at least in part on the current phase signal. For example, a controller, such as controller 250, may determine an output power of induction coil 220 based at least in part on current phase signal 260.

In some embodiments, method 800 may include, at (845), determining a load presence of the induction coil based at least in part on the current phase signal. For example, a controller, such as controller 250, may determine a load (e.g., pan) presence of induction coil 220 based at least in part on current phase signal 260.

Although specific features of various embodiments may be shown in some drawings and not in others, this is for convenience only. In accordance with the principles of the present disclosure, any feature of a drawing can be referenced and/or claimed in combination with any feature of any other drawing.

One example aspect of the present disclosure is directed to an induction heating system for an induction cooking appliance. The induction heating system includes an induction coil configured to inductively heat a load. The induction heating system further includes an inverter system configured to provide an alternating current to the induction coil. The induction heating system further includes a polarity processing circuit configured to determine a polarity signal indicating a first polarity state and a second polarity state of the alternating current to the induction coil. The induction heating system further includes a phase processing circuit configured to determine a current phase signal indicative of a current phase of the induction coil based at least in part on the polarity signal in the first polarity state and the polarity signal in the second polarity state.

In some examples, the phase processing circuit is configured to determine the current phase signal based at least in part on a first gate driver signal when the polarity signal is in the first polarity state and a second gate driver signal when the polarity signal is in the second polarity state.

In some examples, the polarity processing circuit is configured to determine the polarity signal based at least in part on a polarity crossover threshold determined based at least in part on resistor tolerance.

In some examples, the phase processing circuit comprises a low pass filtering circuit configured to filter the current phase signal.

In some examples, the induction heating system further includes a sensing component configured to determine a current measurement signal indicative of current to the induction coil. In some examples, the polarity signal is determined based at least in part on the current measurement signal.

In some examples, the sensing component comprises a passive network circuit.

In some examples, the current measurement signal is determined based at least in part on a voltage signal indicative of a voltage at a node defined between the induction coil and one or more resonant capacitors of the inverter system.

In some examples, the induction heating system further includes a controller configured to determine an output power of the induction coil based at least in part on the current phase signal.

In some examples, the induction heating system further includes a controller configured to determine a load presence of the induction coil based at least in part on the current phase signal.

Another example aspect of the present disclosure is directed to a method for determining a current phase of an induction coil in an induction cooking appliance. The method includes determining a polarity signal indicating a first polarity state and a second polarity state of current to the induction coil. The method further includes determining a current phase signal indicative of the current phase based at least in part on the first polarity state and the second polarity state. The method further includes determining the current phase of the induction coil based at least in part on the current phase signal.

In some examples, determining the current phase signal is based at least in part on a first gate driver signal in the first polarity state and a second gate driver signal in the second polarity state.

In some examples, the method further includes determining, by a sensing component, a current measurement signal indicative of current to the induction coil. In some examples, the polarity signal is based at least in part on the current measurement signal.

In some examples, the sensing component comprises a passive network circuit operatively coupled to a node defined between two resonant capacitors and the induction coil.

In some examples, the method further includes filtering, by a low pass filtering circuit, the current phase signal.

In some examples, the method further includes determining an output power of the induction coil based at least in part on the current phase signal.

In some examples, the method further includes determining a load presence of the induction coil based at least in part on the current phase signal.

Another example aspect of the present disclosure is directed to an induction cooking appliance. The induction cooking appliance includes a user interface comprising one or more user input devices. The induction cooking appliance further includes an induction heating system for an induction cooking appliance. The induction heating system includes an induction coil configured to inductively heat a load. The induction heating system further includes an inverter system configured to provide an alternating current to the induction coil. The induction heating system further includes a polarity processing circuit configured to determine a polarity signal indicating a first polarity state and a second polarity state of the alternating current to the induction coil. The induction heating system further includes a phase processing circuit configured to determine a current phase signal indicative of a current phase of the induction coil based at least in part on the polarity signal in the first polarity state and the polarity signal in the second polarity state.

In some examples, the induction cooking appliance further includes a controller configured to determine an output power of the induction coil based at least in part on the current phase signal.

In some examples, the induction cooking appliance further includes a controller configured to determine a load presence of the induction coil based at least in part on the current phase signal.

In some examples, the phase processing circuit is configured to determine the current phase signal based at least in part on a first gate driver signal when the polarity signal is in the first polarity state and a second gate driver signal when the polarity signal is in the second polarity state second polarity state.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system for an induction cooking appliance, comprising:
an induction coil configured to inductively heat a load;
an inverter system configured to provide an alternating current to the induction coil;
a polarity processing circuit configured to determine a polarity signal indicating a first polarity state and a second polarity state of the alternating current to the induction coil; and
a phase processing circuit configured to determine a current phase signal indicative of a current phase of the induction coil based at least in part on the polarity signal in the first polarity state and the polarity signal in the second polarity state.

2. The induction heating system of claim 1, wherein the phase processing circuit is configured to determine the current phase signal based at least in part on a first gate driver signal when the polarity signal is in the first polarity state and a second gate driver signal when the polarity signal is in the second polarity state.

3. The induction heating system of claim 1, wherein the polarity processing circuit is configured to determine the polarity signal based at least in part on a polarity crossover threshold determined based at least in part on resistor tolerance.

4. The induction heating system of claim 1, wherein the phase processing circuit comprises a low pass filtering circuit configured to filter the current phase signal.

5. The induction heating system of claim 1, further comprising:
a sensing component configured to determine a current measurement signal indicative of current to the induction coil,
wherein the polarity signal is determined based at least in part on the current measurement signal.

6. The induction heating system of claim 5, wherein the sensing component comprises a passive network circuit.

7. The induction heating system of claim 5, wherein the current measurement signal is determined based at least in part on a voltage signal indicative of a voltage at a node defined between the induction coil and one or more resonant capacitors of the inverter system.

8. The induction heating system of claim 1, further comprising:
a controller configured to determine an output power of the induction coil based at least in part on the current phase signal.

9. The induction heating system of claim 1, further comprising:
a controller configured to determine a load presence of the induction coil based at least in part on the current phase signal.

10. A method for determining a current phase of an induction coil in an induction cooking appliance, the method comprising:
determining a polarity signal indicating a first polarity state and a second polarity state of current to the induction coil;
determining a current phase signal indicative of the current phase based at least in part on the first polarity state and the second polarity state; and
determining the current phase of the induction coil based at least in part on the current phase signal.

11. The method of claim 10, wherein determining the current phase signal is based at least in part on a first gate driver signal in the first polarity state and a second gate driver signal in the second polarity state.

12. The method of claim 10, further comprising:
determining, by a sensing component, a current measurement signal indicative of current to the induction coil,
wherein the polarity signal is based at least in part on the current measurement signal.

13. The method of claim 12, wherein the sensing component comprises a passive network circuit operatively coupled to a node defined between two resonant capacitors and the induction coil.

14. The method of claim 10, further comprising:
filtering, by a low pass filtering circuit, the current phase signal.

15. The method of claim 10, further comprising:
determining an output power of the induction coil based at least in part on the current phase signal.

16. The method of claim 10, further comprising:
determining a load presence of the induction coil based at least in part on the current phase signal.

17. An induction cooking appliance, comprising:
a user interface comprising one or more user input devices; and
an induction heating system for an induction cooking appliance, comprising:
an induction coil configured to inductively heat a load;
an inverter system configured to provide an alternating current to the induction coil;
a polarity processing circuit configured to determine a polarity signal indicating a first polarity state and a second polarity state of the alternating current to the induction coil; and
a phase processing circuit configured to determine a current phase signal indicative of a current phase of the induction coil based at least in part on the polarity signal in the first polarity state and the polarity signal in the second polarity state.

18. The induction cooking appliance of claim 17, further comprising:
a controller configured to determine an output power of the induction coil based at least in part on the current phase signal.

19. The induction cooking appliance of claim 17, further comprising:
a controller configured to determine a load presence of the induction coil based at least in part on the current phase signal.

20. The induction cooking appliance of claim 17, wherein the phase processing circuit is configured to determine the current phase signal based at least in part on a first gate driver signal when the polarity signal is in the first polarity state and a second gate driver signal when the polarity signal is in the second polarity state.
